(19) United States
(12) Patent Application Publication
(10) Pub. No.: US 2015/0059967 A1
(43) Pub. Date: Mar. 5, 2015

(54) METHOD FOR MANUFACTURING A COMPOSITE SKIN FORMING A NON-STRIPPABLE SHROUD

(71) Applicant: AIRCELLE, Gonfreville L'Orcher (FR)

(72) Inventors: Frédéric Fosse, Notre Dame-du-Bec (FR); Guy Bernard Vauchel, Harfleur (FR)

(21) Appl. No.: 14/535,466

(22) Filed: Nov. 7, 2014

Related U.S. Application Data
(63) Continuation of application No. PCT/FR2013/050970, filed on May 2, 2013.

(30) Foreign Application Priority Data
May 10, 2012 (FR) 1254258

(51) Int. Cl. B32B 37/00; B29C 53/80

(52) U.S. Cl. CPC B32B 37/00; B29C 53/8066; B32B 2535/00
USPC 156/212; 264/318

(57) ABSTRACT

The present disclosure relates to a method for producing a composite skin forming a non-strippable rotationally-symmetrical collar. The method includes draping fabric plies over a mold, providing a separating line on the draped fabric plies, post-impregnating the draped plies with a resin, curing the resin, removing the resulting skin from the mold using a separating line, and, subsequently, splinting two edges of the skin defined by the separating line.

### CROSS-REFERENCE TO RELATED APPLICATIONS

This application is a continuation of International Application No. PCT/FR2013/050970, filed on May 2, 2013, which claims the benefit of FR 12/54258, filed on May 10, 2012. The disclosures of the above applications are incorporated herein by reference.

### FIELD

The present disclosure relates to the field of the manufacture of composite skins forming shrouds, that is to say having substantially a shape with rotational symmetry about an axis.

### BACKGROUND

The statements in this section merely provide background information related to the present disclosure and may not constitute prior art.

Such composite skins, obtained by arranging fabric plies over a tooling forming a shroud, impregnated by resin beforehand (called “pre-impregnated” plies) or afterwards (called “post-impregnated” or “infused” plies) upon their placing on the tooling, are used especially for air inlets of nacelles for turbojet engines of aircrafts, where they are then perforated and coupled with honeycomb cellular structures.

In this manner, we obtain sandwich structures called “360°”, that is to say allowing to achieve an acoustic absorption function over the entire inner periphery of the air inlet: such structures are known for example from documents FR 2 847 304, FR 2 931 205 and WO 2005/090156.

A constant problem involved in the manufacture of such sandwich structures is that the skin forming the shroud has generally convex zones which exclude the possibility of stripping this skin from a tooling in a single operation.

We must therefore either carry out a complex tooling comprising several portions movable relatively to each other (called “keys”) or carry out the composite skin into a plurality of portions that will then be connected to each other.

In either case, the operations are complex, and give rise to many aerodynamic accidents at the surface of the skin obtained at the end of the process, in the connection zone either between the different keys of the tooling, or between various portions forming the skin.

### SUMMARY

The present disclosure provides a method for manufacturing a composite skin forming a shroud comprising the successive steps:
draping fabric plies, either pre-impregnated, or dry, on a mold, said mold forming a shroud and presenting a bulge preventing the stripping of the composite skin by axial sliding of said skin on said mold,
providing for a separation line defining two edges on the obtained draping,
post-impregnating this resin draping if the deposited fabric is dry,
baking this resin,
removing the obtained skin from the mold using the separation line,
splinting both edges of the skin.

Therefore, to remove the baked skin from the mold forming a shroud, it is sufficient to space away the two edges of this skin located on either side of the separation line, by using the elasticity of this skin.

The present disclosure thus allows greatly simplifying the manufacture of the composite skins forming non-strippable shrouds, and limit aerodynamic accidents on the surface of such skins.

According to other features of the present disclosure:
said separation line is carried out by means of a groove formed in said mold forming a shroud, in which a cutting tool is introduced before the finish of the resin;
a strip is placed in said groove prior to impregnation of the plies with the resin;
said separation line is carried out with at least a fixed strip integral with said mold forming a shroud, against which abut two edges of the plies draping;
a strip cover is placed on said strip prior to impregnation of the plies with the resin;
said separation line is carried out by a simple cutting of the plies draping by its thickness, with a cutting by full thickness followed by cuttings of a portion only of the draping thickness, allowing to obtain stepped edges;
said separation line is carried out by covering two edges of the draping;
a separator is placed between the two edges of the draping which are adjacent to the separation line prior to impregnation of the plies with the resin;
said separation line is carried out by covering a cavity formed on the mold forming the shroud;
said separation line is carried out by draping plies on a mold forming a shroud of dimensions greater than that of the final part, in order to obtain an open skin, and the two edges of this draping which are adjacent to the separation line are machined after baking of the resin;
said separation line is carried out according to a direction selected from the group comprising the longitudinal direction, the transverse direction, and any intermediate position between these two positions;
said resin draping is impregnated if the fabric is dry and used, in particular in the “infusion” version, using a bladder that is applied on this draping against the mold forming a shroud, and which is put under vacuum;
the splinting of both edges of the skin is carried out on or inside a key tooling;
a honeycomb cellular structure is brought on said splinted skin disposed on or inside said key tooling;
said composite skin is glued to the inside or to the outside of a set formed of a honeycomb cellular structure fixed to another composite skin, and the splinting of both edges of the skin is carried out on or inside this set.

If necessary, the acoustic perforation of the skin can be done after polymerization of this skin, before implantation of the cellular structure. Alternatively, this skin can be perforated after implantation of the cellular structure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a top view of a mold forming a shroud on which are draped fabric plies intended to form a composite skin, corresponding to a first form of the method according to the present disclosure;

FIG. 1a is a detailed view of Zone I of FIG. 1;

FIGS. 1b to 1f are views similar to those of FIG. 1a, highlighting the various steps of this first form of the method according to the present disclosure;

FIGS. 1g and 1h are respectively similar to FIGS. 1 and 1a, and relate to another form of the first form of the method according to the present disclosure;

FIGS. 2 to 2i are respectively similar to FIGS. 1a to 1h, and relate to a second form of the method according to the present disclosure;

FIGS. 3 to 3e relate to a third form of the method according to the present disclosure, being denoted that FIG. 3b is a cross-sectional view of the separation zone of the draping disposed on the mold forming a shroud;

FIGS. 4 to 4e are cross-sectional views of this separation zone, for a fourth form of the method according to the present disclosure;

FIGS. 5 to 5b are cross-sectional views of this separation zone, for a fifth form of the method according to the present disclosure;

FIGS. 6 to 6a are cross-sectional views of this separation zone, for a sixth form of the method according to the present disclosure;

FIGS. 7 and 8 are views similar to those of FIGS. 1 and 2, in the case where the separation line on the draping is transverse;

FIG. 8a is a detailed view of Zone VIII of FIG. 8;

FIG. 9 schematically shows an form of a composite skin on a mold forming a shroud, when this skin is disposed outside of this mold;

FIG. 9a illustrates the splinting of the thus obtained composite skin, disposed outside a key tool;

FIG. 9b illustrates the placing of a honeycomb cellular structure on the composite skin splinted at the end of step of FIG. 9a;

FIGS. 10 to 10b illustrate steps similar to those of FIGS. 9 to 9b, when the composite skin is disposed inside a mold forming a shroud, then splinted and covered with a honeycomb cellular structure inside a key tool;

FIGS. 11 to 11c are respectively similar to FIGS. 9a 9b, and relate to the form of FIG. 6 or 6a, being denoted that FIG. 11b is an enlargement of Zone XI of FIG. 11a;

FIGS. 12 to 12c are respectively similar to FIGS. 10 to 10b, for an form similar to that of FIGS. 6 to 6a, being denoted that FIG. 12b is an enlargement of Zone XII of FIG. 12a; and

FIGS. 13a and 13b are views of another form of the method according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In addition, note also that care was taken to represent for each of the figures a reference frame XYZ, each axis of which is collinear respectively to the longitudinal, transverse and vertical directions of an aircraft on which is mounted a nacelle incorporating at least one composite skin obtained by the method according to the present disclosure.

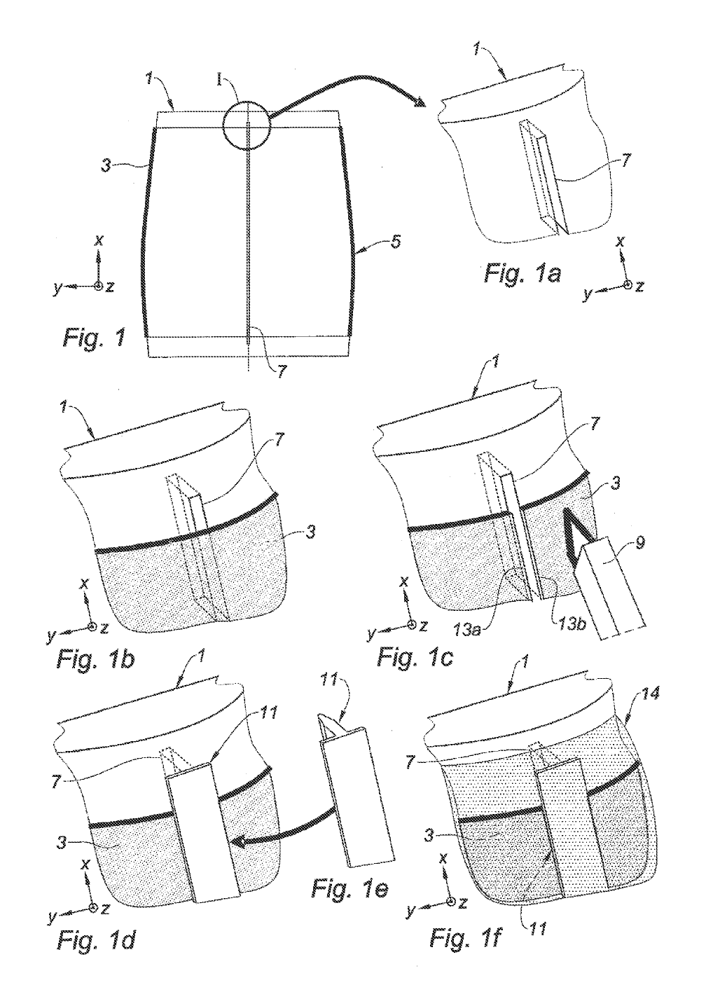

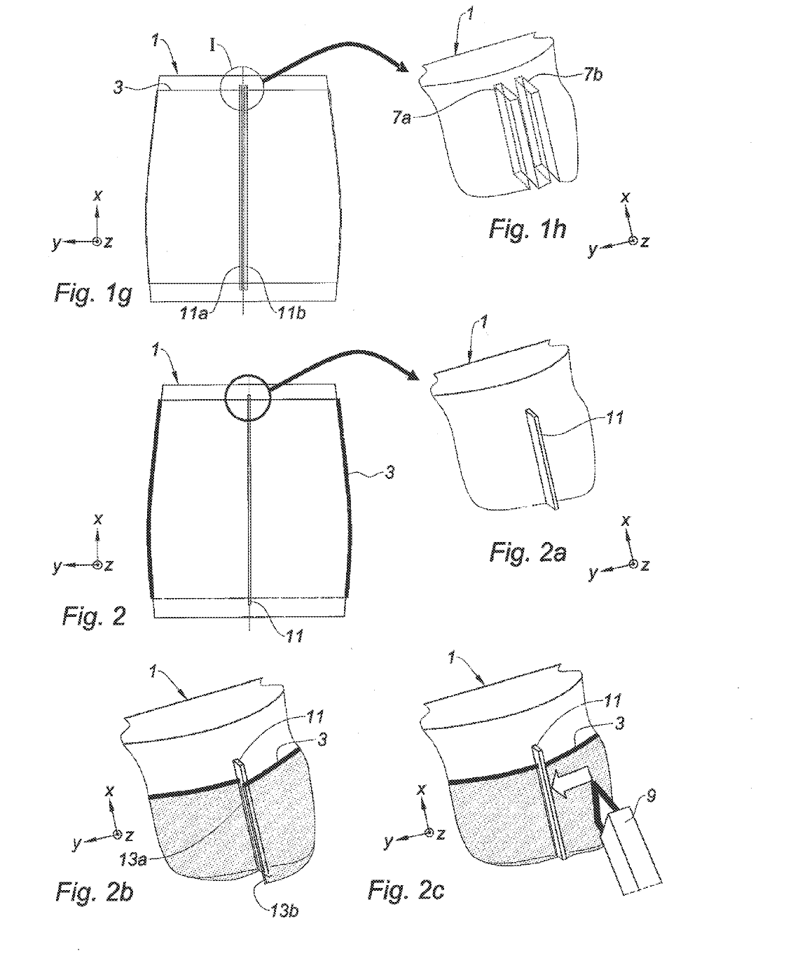

Referring to FIG. 1, a mold forming a shroud 1 is shown, carried out for example of steel or other metal alloys.

The mold 1 is intended to be covered with a fabric draping intended to form a composite part presenting a shape substantially with rotational symmetry.

As seen in FIG. 1, the mold 1 presents a bulge 5 preventing the stripping of the composite skin by simple axial sliding of this skin on this mold.

To enable this stripping, a longitudinal groove 7 formed in the thickness of the mold 1 is provided, and extending slightly beyond the area of the mold intended to be draped by the fabric plies 3, as is seen in particular in FIG. 1b.

To carry out the composite skin, we start with draping the fabric plies over the entire periphery of the mold 1, including the groove 7, as can be seen in FIG. 1b.

Then, as seen in FIG. 1c, by means of a manually or automatically operated cutting tool 9, the plies draping is cut along the groove 7.

Next, as seen in FIG. 1d, a strip 11 substantially presenting a T-section is brought to the inside of the groove 7, so as to seal this groove along its entire length.

And then the entire draping is covered, including the strip 11, with a flexible bladder 14 that is put under vacuum, thus providing the sealed covering of the strip 11 and the draping 3 set.

In case of infusion of resin, the polymerizable resin is introduced under pressure below the flexible bladder 14 (“post-impregnation” also called “infusion” of resin) so that this resin impregnates the entire draping.

The temperature of the thus obtained set is raised, for example inside an autoclave, so as to cure the resin.

Thereafter, the flexible bladder is removed, then the strip 11, and the thus obtained composite skin is removed from the mold 1 using the separation line previously carried out along the groove 7, and using the relative flexibility of this skin.

Note that two substantially parallel grooves 7a and 7b can be provided, as shown in FIG. 1h, allowing to perform two cutting lines in the draping, for example when it is desired that the thus obtained composite skin presents a diameter more significant than the final need.

Note that in this particular case, a strip similar to that of FIG. 1e can be provided, but presenting two feet intended to insert respectively in the grooves 7a and 7b.

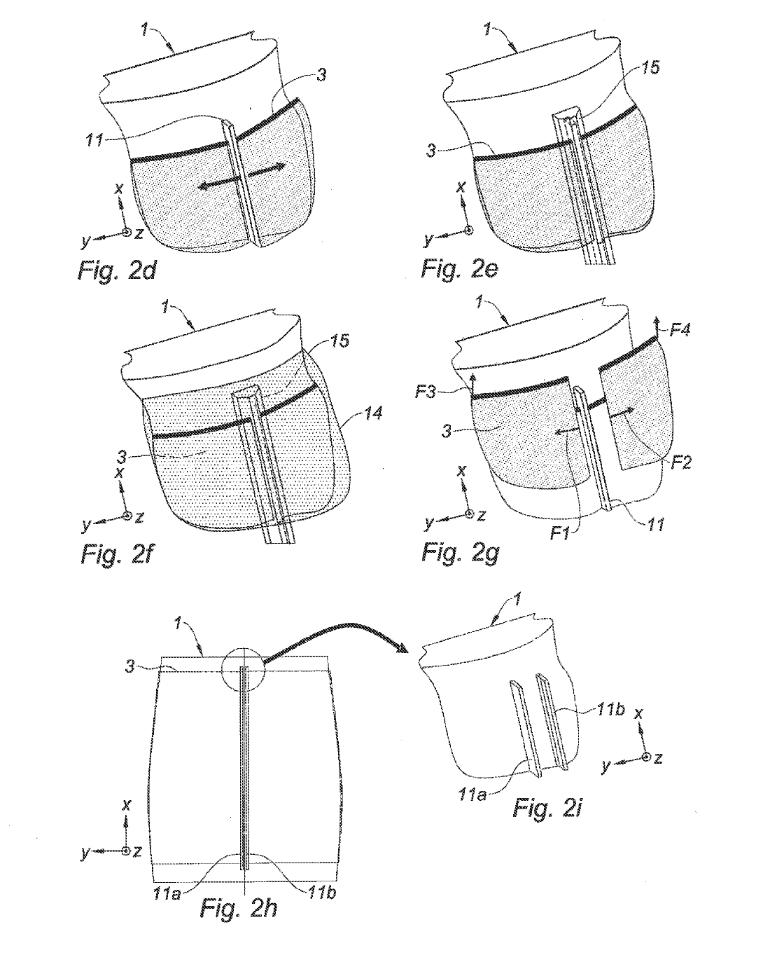

In the form of FIG. 2, a strip 11 fixedly mounted on the mold 1, and extending longitudinally slightly beyond the two ends of the draping 3, as can be seen in particular in FIGS. 2 and 2b.

In this form, the draping 3 can be carried out so that one of its edges 13a abuts against the strip 11, and that the other of its edges 13b slightly covers this strip 11, being denoted that in the following step shown in FIG. 2c, the draping overlength is cut using a tool 9 so that both edges thereof abut properly on both sides of the strip 11.

In another form represented in FIG. 2d, both faces of the strip 11 can be used as faces of start and finish of the draping, the folding of the various plies forming this draping being carried out upon the abutment against the faces of this strip: in this case, no cutting tool is required.

In either of these two forms, the strip 11 is then covered with a strip cover 15, which is in fact a female part capable to receive this strip 11 while pressing the adjacent edges of the drape 3.

Step 2f is similar to step 1f: this step consists indeed in covering the draping and the strip cover 15 of a bladder 14 which is put under vacuum, and then introducing the resin under pressure if the fabric is dry and used in the “infusion” version, the thus obtained set being placed in an autoclave to cure the resin.

The stripping of the thus obtained composite skin is shown in FIG. 2g: as in the preceding form, the elasticity of this skin is used to space away the two adjacent edges of this skin of the strip 11 (arrows F1, F2), to axially (arrows F3 and F4) get this skin out of the mold 1.

Note that alternatively, fabric plies pre-impregnated with resin can be used. This is also applicable to the forms which will be described hereinafter.

In still another form as shown in FIGS. 2h and 2i, it is seen that two strips 11a and 11b can be provided, similarly to the two grooves 7a and 7b of the previous form, in which case a two-slot strip cover must be considered, suitable for fitting respectively on these two strips 11a and 11b.

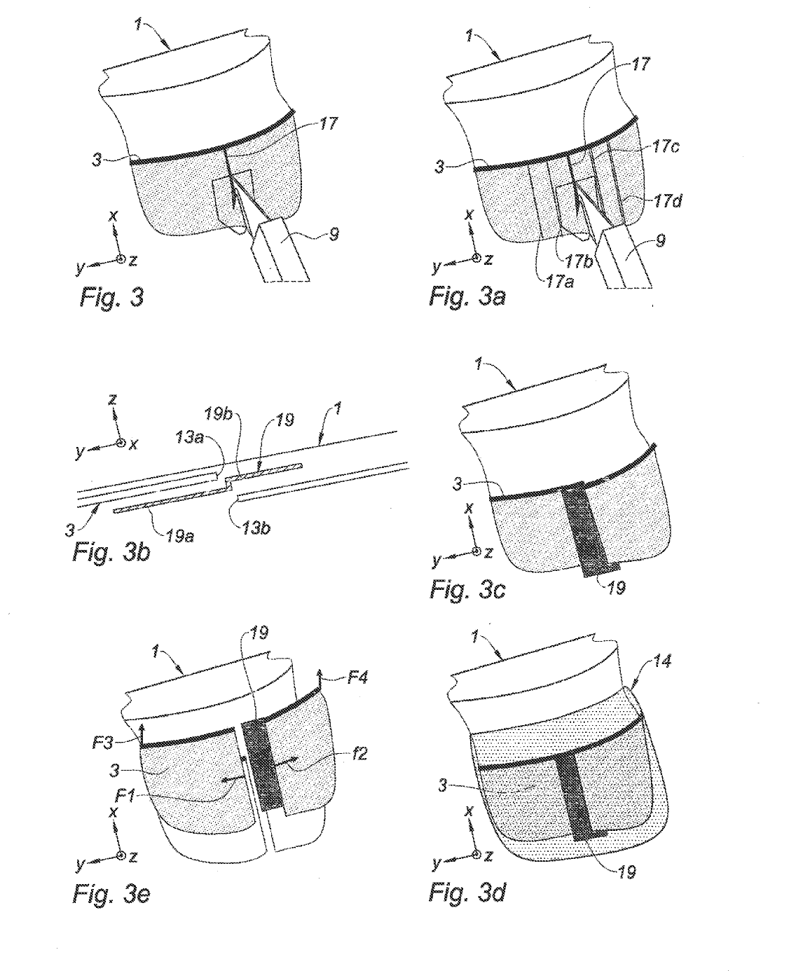

In the form of FIGS. 3a, 3e, neither a groove nor a strip is provided at the surface of the mold 1.

As shown in FIG. 3, the draping 3 is simply cut at full skin using a cutting tool 9, as indicated by the cutting line 17.

As shown in FIG. 3, a cutting 17 on a thickness of the draping 3 can be carried out, as well as a plurality of adjacent stepped cuttings 17a, 17b, 17c, 17d, on the different thicknesses of the draping.

After this cutting is carried out, as shown in FIGS. 3b and 3c, a sheet of a separator 19 is placed between the two edges 13a and 13b of the draping.

This sheet 19, which can be carried out for example of PTFE (polytetrafluoroethylene) is selected so that its outer face 19a is polymerizable with the resin, while its inner face 19b (that is to say its face located opposite to the mold 1) is not.

This separator 19 allows, during the resin impregnation step (see FIG. 3d similar to that of FIGS. 1f and 2f) if the fabric is dry and used in the “infusion” version, to prevent the resin from slipping between the two edges 13a and 13b of the draping.

Once the resin polymerization step is done, the two edges of the thus obtained composite skin can be spaced away, and removed from the mold 1, as shown in FIG. 3e.

The overflowing portion of the separator 19 can thereafter be suppressed, for example by cutting.

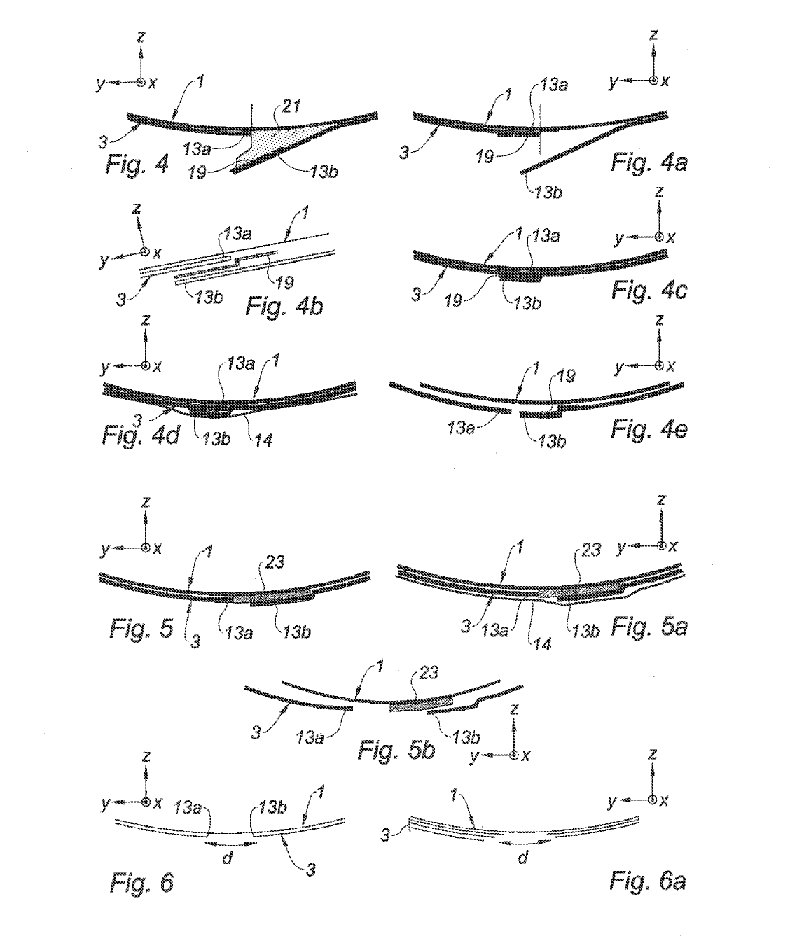

The form of FIGS. 4a, 4e differs from the previous one in the sense that it provides a cover between the edges 13a and 13b of the draping 3.

As in the previous form, the placing of a separator 19, presenting the same characteristics of polymerization on its faces 19a and 19b as described in connection with FIG. 3b, is considered.

In the variant shown in FIG. 4, this separator is glued under the edge 13b of the draping 3, which edge is held away from the other edge 13a of this draping by a strip 21 of suitable shape.

In another form shown in FIG. 4a, the separator 19 is glued to the edge 13a of the draping 3, intended to be covered by the other edge 13b of this draping.

In one case as in the other, once the edge 13a of the draping 3 is covered by the edge 13b, we come to the configuration of FIG. 4c, in which a mutual covering of these two edges can be observed, the separator 19 presenting a substantially bayonet section.

FIG. 4d illustrates the positioning of the flexible bladder 14, allowing the impregnation of the draping by the pressurized resin if the fabric is dry and used in the “infusion” version.

FIG. 4e shows the result obtained after autoclaving:

the separator 19 remains integral with the edge 13b of the draping, due to polymerization of the resin, but detaches easily from the other edge 13a of the draping, therefore allowing the spacing away of both edges of the thus obtained composite skin in view of its axial retraction from the mold 1.

In the form of FIGS. 5a, 5b, a longitudinal cavity 23 integral with the mold forming the shroud 1 is provided.

The draping 3 is therefore disposed so that its edge 13a abuts between this cavity 23, and its other edge 13b covers this cavity 23 almost entirely.

Therefore, after disposition of the flexible bladder 14 (FIG. 5a), the impregnation of the resin draping (if the fabric is dry and used in the “infusion” version) and autoclave baking, the two edges of the thus obtained composite skin can be moved, as seen in FIG. 5b, these two edges having a geometry appropriate for their subsequent covering, because of the bayonet shape conferred by the cavity 23 to the edge 13b of the composite skin, as seen in this FIG. 5b.

The form of FIGS. 6 and 6a shows that it is also possible to provide for a draping on a mold forming the shroud 1, having dimensions greater than that desired for the final composite skin.

In this case, the mold 1 is draped only over part of its periphery, so as to leave a circumferential distance d between the two edges 13a and 13b of this draping.

The various plies of this draping can also be disposed so that they present a stepped configuration, as seen in FIG. 6a.

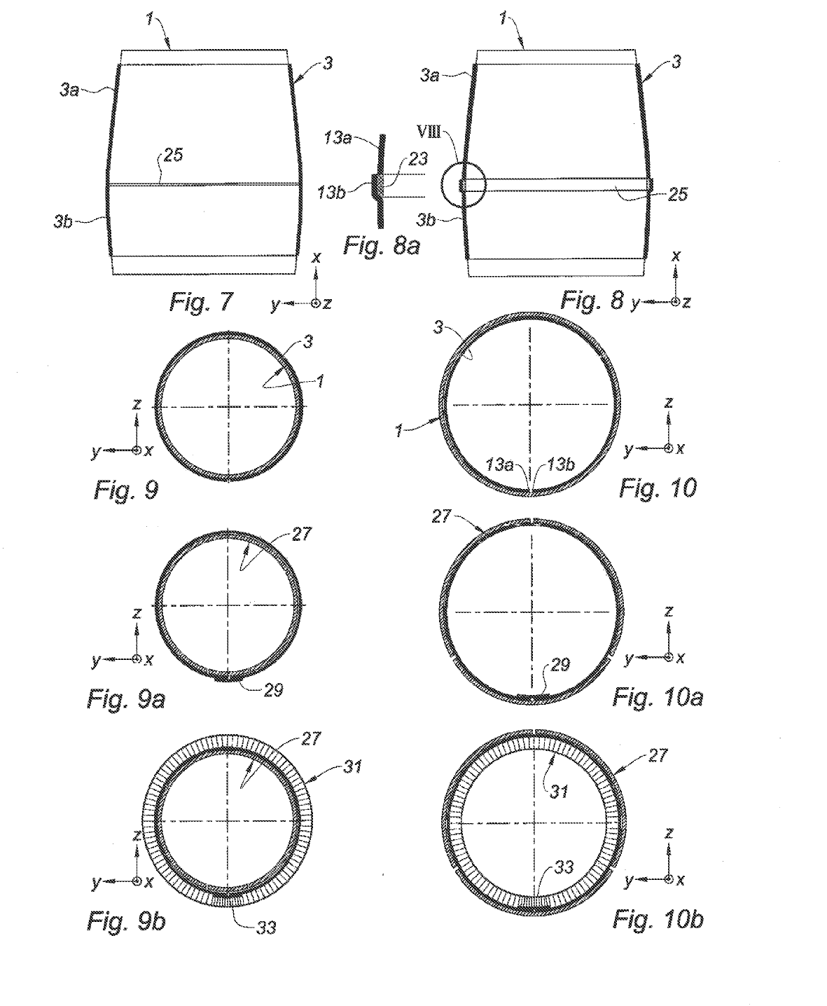

FIG. 7 shows that the foregoing precepts can be applied to the carrying out of a transverse junction zone 25 between two halves 3a and 3b of the draping 3.

This transverse junction line 25 is then to the right of the bulge 5 of the mold forming the shroud 1.

FIGS. 8 and 8a illustrate the particular case where this junction line 25 is carried out in accordance with the precepts of the form of FIGS. 5a, 5b, that is to say with the carrying out of a cavity 23 on the entire circumference of the mold forming the shroud 1.

In the latter case, as in the form of FIGS. 5a, 5b, we thus end up with a composite skin comprising two edges 13a and 13b which cover one another, this covering being in this case circumferential.

FIGS. 9a, 9b, summarize the manufacturing of a composite skin according to any one of the forms of FIGS. 1 to 5, in the case where the draping is carried out on a mold forming the male shroud 1.

As seen in FIG. 9, thus we start by the draping 3 on the outer periphery of the mold 1.

After the steps of resin impregnation if the fabric is dry and used in the “infusion” and baking version, the obtained composite skin can be stripped from the mold 1 by elastic deformation of this skin, as indicated hereinbefore.

This skin is then disposed on a key tooling 27, that is to say on a tooling including a plurality of movable elements relative to one other, allowing removal of the composite skin, including when it became a single-piece, that is to say when these two opposite edges 13a and 13b have been joined to each other.

On this key tool 27, a splinting 29 of two edges 13a, 13b of the composite skin is carried out.

This splinting is typically carried out by provision and polymerization of an external composite element.

Then, in the case where it is desired that the composite skin is covered with an acoustically absorbent structure, the outer periphery of this composite skin can be brought, by gluing, a honeycomb cellular structure 31, which can be densified in the zone 33 that is opposite of the splinting 29.

Once all these operations are performed, the key tooling 27 can be dismounted so as to recover the thus obtained part.

Note that the acoustic perforation in the skin can be carried out after polymerization of this skin, prior to implantation of the cellular structure. Alternatively, this skin can be perforated after implantation of the cellular structure.

FIGS. 10a to 10b are similar to FIGS. 9 and 9b, and relate to another form in which the plies draping is carried out inside a mold 3, then treated in conformity with the method according to the present disclosure.

Specifically, once the composite skin obtained after the various steps described hereinbefore, this skin can be removed from inside the mold 1 by elastic approximations of these two edges 13a, 13b.

The steps of skin splinting inside a key tooling 27 (FIG. 10a), and then the provision of a honeycomb cellular structure 31 (FIG. 10b), are then similar to those described regarding FIGS. 9a and 9b.

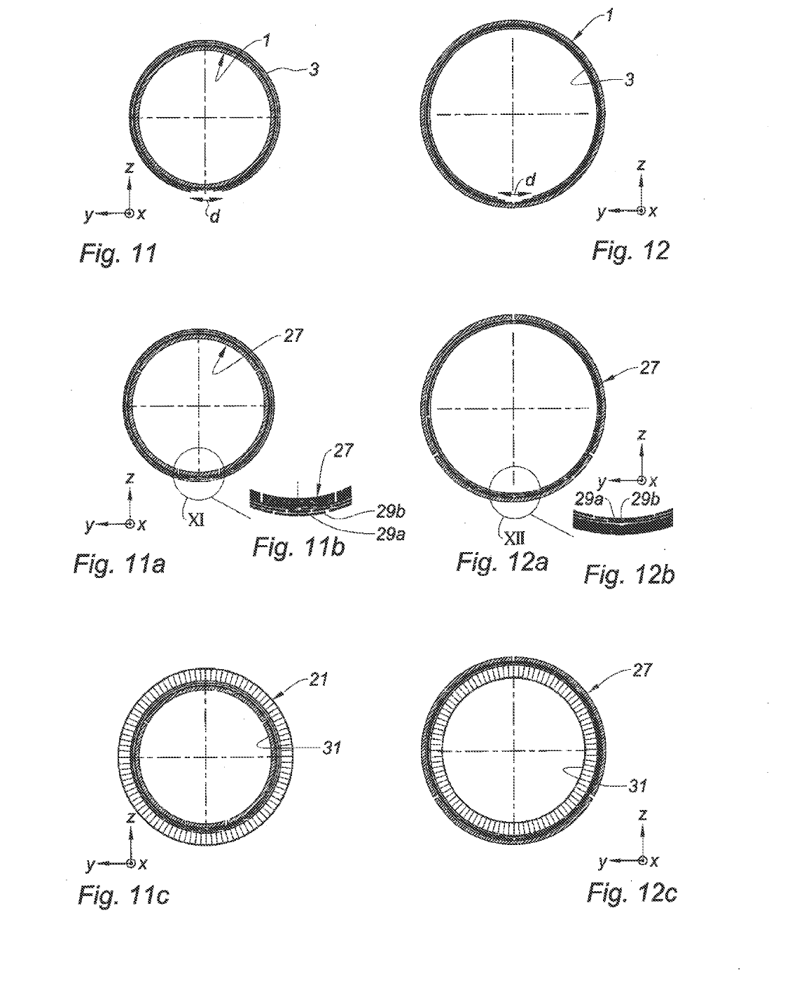

FIGS. 11 to 11c are similar to FIGS. 9 and 9b, but relate to the form of the method according to the present disclosure described in FIG. 6a.

As indicated hereinbefore, in this particular form, the plies draping 3 is carried out on a mold forming a shroud 1 presenting dimensions greater than those of the part desired to obtain in the end.

The stepped draping can be seen in FIG. 11, corresponding to the one illustrated in FIG. 3.

FIG. 11b shows that the splinting on a key tooling 27 in this case is performed by providing a plurality of external composite elements 29a, 29b.

The form of FIGS. 12 to 12c is similar to that of FIGS. 11 to 11c, but in the case where the plies draping 3 is carried out inside a mold forming a shroud 1, and/or the splinting and provision of a cellular structure are carried out inside a key tooling 27.

As can be understood in the light of the foregoing, the method of the present disclosure allows carrying out composite skins in the form of shrouds, that is to say 360°, presenting minimal aerodynamic accidents, with extremely simple tooling.

This method, according to which a separation line is carried out at a suitable location of the draping of fabric plies, and the composite skin obtained by elastic deformation relative to its mold is recovered, allowing to obtain composites skins having shapes substantially with rotational symmetry, which would be impossible to obtain without complex key tooling.

Composite skins forming shrouds can in particular be obtained, presenting bulges and hollow zones excluding any translational stripping with respect to a traditional mold.

Of course, the present disclosure is in no way limited to the described and represented forms, provided only as examples.

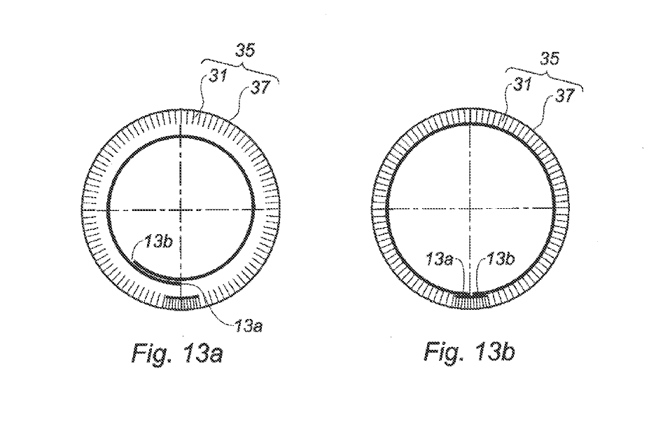

This is how for example we can also consider placing a composite skin obtained by the method described hereinabove, inside or outside of a set 35 formed of a honeycomb cellular structure 31 fixed to another skin or composite shroud 37 already polymerized such as in RTM, and the splinting is carried out on both edges of the skin 13a, 13b on or inside this set 35, as shown in FIGS. 13a and 13b appended hereinto.

In this form, the set 35 constitutes a single-piece housing on which the composite skin obtained by the above method is brought by gluing.

What is claimed is:

1. A method for manufacturing a composite skin forming a shroud comprising the steps:
draping fabric plies, either pre-impregnated or dry, on a mold, said mold forming the shroud and presenting a bulge preventing stripping of the composite skin by axial sliding of said composite skin on said mold;
providing a separation line defining two edges on the fabric plies draped ng;
post-impregnating a resin with the fabric plies when the fabric plies are dry;
baking the resin;
removing from said mold a skin obtained using the separation line; and
splinting the two edges of the skin.

2. The method according to claim 1, wherein said separation line is carried out by means of a groove formed in said mold forming the shroud, and a cutting tool is introduced before the post-impregnating of the resin.

3. The method according to claim 2, wherein a strip is placed in said groove prior to impregnation of the fabric plies with the resin.

4. The method according to claim 1, wherein said separation line is carried out with at least one fixed strip integral with said mold forming the shroud, against which abut the two edges of the fabric plies draped.

5. The method according to claim 4, wherein a strip cover is placed on said strip prior to impregnation of the fabric plies with the resin when the fabric plies are dry and used in an “infusion” version.

6. The method according to claim 1, wherein said separation line is carried out by simply cutting the draped fabric plies by thickness thereof.

7. The method according to claim 6, further comprising cutting in only one portion of the thickness to obtain stepped edges.

8. The method according to claim 1, wherein said separation line is carried out by covering the two edges of the draped fabric plies.

9. The method according to claim 8, wherein a separator is placed between the two edges of the draped fabric plies which are adjacent to the separation line prior to impregnation of the fabric plies with the resin when the fabric plies are dry and used in an “infusion” version.

10. The method according to claim 1, wherein said separation line is carried out by covering a cavity formed on said mold forming the shroud.

11. The method according to claim 1, wherein said separation line is carried out by draping the fabric plies on said mold forming the shroud having dimensions greater than dimensions of a final part to obtain an open skin, and the two edges of the draped fabric plies which are adjacent to the separation line are machined after baking of the resin.

12. The method according to claim 1, wherein the separation line is carried out according to a direction selected from the group consisting of a longitudinal direction, a transverse direction, and any intermediate position between said two directions.

13. The method according to claim 1, wherein said draped fabric plies are impregnated with the resin when the fabric plies are dry and used in an “infusion” version by means of a bladder that is applied on the fabric plies draped against said mold forming the shroud, and that the bladder is put under vacuum.

14. The method according to claim 1, wherein the splinting is carried out on both edges of the skin on or inside a key tooling.

15. The method according to claim 14, wherein a honeycomb cellular structure is brought to said splinted skin disposed on or inside said key tooling.

16. A method according to claim 1, wherein said composite skin is glued on an inside face or an outside face of a set formed of a honeycomb cellular structure fixed to another composite skin or shroud already polymerized, and the splinting of both edges of the skin is carried out on or inside of the set.
